(19) United States
(12) Patent Application Publication
(10) Pub. No.: US 2002/0095305 A1
(43) Pub. Date: Jul. 18, 2002

(54) System and method for evaluation of ideas and exchange of value

(76) Inventors: Haralabos E. Gakidis, Newton, MA (US); Ovidiu Marina, (US)

Correspondence Address: HALE AND DORR, LLP, 60 STATE STREET, BOSTON, MA, 02109

(21) Appl. No.: 09/933,458

(22) Filed: Aug. 20, 2001

Related U.S. Application Data
(60) Provisional application No. 60/226,629, filed on Aug. 21, 2000.

(51) Int. Cl. G06F 17/60

(52) U.S. Cl. 705/1

(57) ABSTRACT

A network system manages the routing of ideas among submitters and evaluators and assigns values to submitters and evaluators based on interactions and outcomes.

### CROSS-REFERENCE TO RELATED APPLICATION

This application claims priority from provisional application no. 60/226,629, filed Aug. 21, 2000, which is expressly incorporated herein by reference.

### FIELD OF THE INVENTION

The present invention relates to the allocation of internal and affiliated resources for the selection and advancement of ideas from within a large pool of ideas available to an organization.

### BACKGROUND OF THE INVENTION

“Ideas,” as used herein, are meant to broadly include intangible concepts and intellectual property, including business ideas, technical ideas, invention disclosures, and also creative ideas, such as music, community initiatives or creative written product. The term “organization” refers broadly to a collection of individuals that are involved in the conception, selection, and advancement of ideas in a setting. An organization thus includes (without limitation) a venture capitalist firm and all its affiliates that provide it with deal flow and help select through it; a corporation trying to select among internal and external ideas using its employees, consultants or affiliates; or an online community seeking to promote community initiatives.

Venture capital financing has increased significantly in recent years. Currently, many ideas are being presented to venture capitalists (VCs) and other financiers for backing, but it is difficult for such financiers to evaluate the large number of ideas and plans to separate the promising ideas from those that are less promising. In other words, while there is high “deal flow,” there are practical difficulties in evaluating all the ideas. One of the side effects is that VCs primarily fund ideas that are introduced to them by acquaintances, leaving promising ideas brought in by unknown people to languish.

Services have been created to try to bring together companies and potential financiers. For example, a company and website called Garage.com invites entrepreneurs to submit business plans and then has a staff of people to evaluate those submitted plans. The system then tries to match financiers with these potential businesses. The process on Garage.com thus appears to begin when an individual has already prepared a business plan and is ready to submit that plan, although in some cases, there are incubators/financiers that will work with people with ideas at an earlier stage.

Potential entrepreneurs may need assistance, however, in order to develop and refine their ideas and business plans before attempting to present the idea to financiers. On the side of the financiers, it would be desirable to have a system for assisting financiers in evaluating and prioritizing the deals through market mechanisms, and it would be especially desirable to have a recommendation from someone who has credibility with the financiers.

To obtain expertise, an entrepreneur must hire talent, but such an approach may have two drawbacks. Hiring talent may be expensive for an individual or pre-finance start-up venture, and the entrepreneur may not know how to identify desirable individuals for consultation.

Meanwhile, with the increased activity in business formation and financing, there are individuals with talents and expertise and an interest in assisting new enterprises, but not the access and information to know where the opportunities are, or the ability to review a number of opportunities where their limited involvement may be desirable, or the ability to discover such deal flow without jeopardizing their privacy and anonymity.

Corporations face a similar problem in that employees who come up with an idea for a new process or product typically have to repeatedly get approval from all of the managers in their chain of command. Any of these managers can decide to kill the idea without consulting other members of the corporation.

Some corporations have a system of idea approval, whereby groups of managers determine whether ideas should be pursued, with more senior managers reviewing ideas that have already passed the review of a set of more junior managers. This process has many flaws, not the least of which is that usually the manager deciding on an idea is also the manager whose position is most threatened by the potential success of the proposed idea.

There are a number of other current systems for evaluating ideas, such as the review from a corporate patent review committee. Typically in such a committee, individuals who may be from different disciplines within an organization evaluate invention disclosures to decide which ones should be filed as patent applications based on factors such as likelihood of successful patenting, correlation with an existing product, and opportunities to obtain broad claims. In such committees, an inventor whose invention disclosure is turned into a patent application may be provided with a modest monetary award for the filing and/or issuance of that patent application. With the committee system as described above, there is typically one layer of people evaluating patent applications as they are received, and the ultimate decision to file an application is a yes or no decision. The people who evaluate the patent applications for submission are generally not evaluated themselves, but are typically limited only to a number of applications or a patent filing budget to determine what gets filed. Once the decision is made to go forward, the committee generally leaves it to the inventor and the patent attorney to modify how the idea is presented.

### SUMMARY OF THE INVENTION

In typical settings, a large set of ideas are selected among by a small group of people within an organization. As a result, the ultimate success of an idea may depend on many factors that have no relation to the idea but instead are related to the modus operandi of the organization in which it will be evaluated. The path of an idea from individual to individual inside the organization often depends on the hierarchy and personal relations inside the organization, not a scientific and objective system. To get promoted and reach the appropriate review committee, ideas must rely on informal networks of people being able to forward the right idea to the right person. Although the individuals that become part of the path of an idea inside the organization (the “reviewers”) may have impeccable credentials for the positions they hold, their primary role is not to promote ideas. In fact, these individuals may well feel threatened by particular ideas that are beneficial to their organization or be concerned that the ideas are distracting to their subordinates or costly to their budget. Furthermore, these individuals usually lack expertise in the necessary nuances of the particular ideas they judge, and are not necessarily in contact with the ideal set of people to whom the idea should be referred.

The present invention addresses this failing of the state of the art by providing a scientific and quantifiable system and method for evaluating and promoting ideas inside organizations. This includes a system and method for selecting the reviewers by determining the relevant members who are best suited to judging each particular idea from a large group of individuals who may provide feedback on ideas, with potentially a different subset of individuals reviewing every idea. Based on the observed interactions of the reviewers with the idea itself and also with each other, the value of each idea is derived in an objective, scientific manner. To encourage the dissemination of ideas and to limit the effect of company politics on the development of ideas as found in the prior art, users of the system can opt to remain anonymous.

To achieve coordination within the organization and to communicate valuation within the system through the actual exchange of value, the present invention provides a form of private currency related to each idea, termed “ideashares,” which terminology is used here for ease of discussion and is not meant to imply or exclude any features not explicitly stated. Tied to the ultimate success of the individual idea, idea shares provide an incentive mechanism for sharing information and promoting ideas. Such a mechanism is lacking in typical idea evaluation processes.

From the perspective of entrepreneurs seeking to promote innovative ideas, the system of the present invention provides them with:

i. a scientific framework for submitting ideas and having these ideas evaluated; and

ii. a vehicle for sharing the potential upside of their ideas with individuals that can help promote their ideas.

In the context of VC financing, the present invention can exist, for example, as a stand-alone system on the Internet for entrepreneurs, experts and financiers. Such a system would allow entrepreneurs with ideas to obtain expert assistance and also to initiate team building in exchange for idea shares but without cash outlay. This assistance would be provided by the experts, who may be professionals from different fields eager to participate in promising ideas in a limited fashion. The system would allow experts to provide limited commitment to select ideas without compromising their privacy and without detracting from their other occupations. By offering limited services to a number of startups, experts would then be able to create their own venture portfolio.

In the process, the system would also provide potential financiers (and experts) with a method for rating and thereby filtering ideas such that promising ideas are more likely to be funded. The system would allow financiers, i.e., members of the organization that can allocate funds to an idea, to view ideas that have been rated, pre-screened, and refined by the population of experts on the system. All parties would benefit from the interactions being performed through and recorded and stored by the system, thus creating a written record of the communications relating to individual ideas, entrepreneurs, experts and financiers.

The system, or a modified version, could also be implemented over a company's intranet as a way of allowing employees to provide and refine ideas within an organization. In today's entrepreneurial economy, research-driven companies are placing ever-increasing demands on an in-house innovation advocate. This advocate, who may be the head of R&D or corporate ventures, currently relies on a loosely organized network of existing processes and resources. In such an internal network, idea shares would typically not be tied to potential equity, but would typically be used to evaluate interactions based on outcomes from the ideas. The system, or a modified version, could also be implemented over a publicly accessible web site to measure and evaluate interactions between and among individuals.

The present system goes beyond simply rating ideas by popularity and/or similarity. In the prior art, attempts have been made to evaluate content made available to individual users on a system, such as, for example, a web site, based on the number of times the content was accessed within the system or other straightforward measures of activity. These types of systems have been implemented in some companies for internal idea management, by song-sharing companies such as Napster, as well as consumer goods companies such as Amazon.

A limitation of straightforward activity-based measures for rating ideas is that the usefulness of the user for rating an idea is limited to the user's observed interaction with that idea. This limitation is significant when rating ideas because several users with the exact same response to an idea, from the perspective of the system, may still have vastly different opinions of the idea. For example, every user that spends ten minutes on a certain idea logs the same response with the system, even though one user may have spent ten minutes laughing at how ignorant the idea seems whereas another user may have spent ten minutes calling a friend to share the new piece of information.

In the present system, this limitation is addressed by tying the user's benefit from interacting with an idea to the ultimate success or rating of the content within the whole system through the use of idea shares. This enables the interpretation of actions which formerly were strictly voluntary and provided no ulterior benefit to the user as being a reflection of each user's true opinions about the value of the content to the system as a whole, as some possible benefit is attached to their actions. Because a user's benefit from interacting with the content is tied to the ultimate success or rating of the content within the whole system, the user interactions reflect the user's opinions about both the risk as well as the value of the content to the organization.

A further limitation of such an approach to the rating of ideas is that the value of an idea in an organization may be best determined by examining the specific characteristics of the users that interact with each idea rather than the overall level of activity generated by that idea. For example, an idea about a new technology may be more valuable to financiers if it was highly regarded by some scientists and some marketing experts rather than by a great number of scientists only, as the former can be deduced to have both sales and scientific potential, whereas the latter may be a great invention but would never sell. By selecting reviewers based on their desirable characteristics vis-a-vis particular ideas, the present system can provide better estimates of an idea's valuation. Such a system, often referred to as “collaborative filtering” (e.g., U.S. Pat. Nos. 6,266,649 and 6,064,980), is limited in the context of evaluating ideas because ideas are not static but rather evolve as a result of interacting with the reviewers.

Moreover, collaborative filtering systems generally perform poorly with new content as it enters the system as they must rely on historical interactions between the users and the content to provide ratings and coordinate the dissemination of information. This is clearly not the case in the present invention, where incentive management techniques, made possible by idea shares, can also be used to coordinate the dissemination of information. For example, when ideas enter a system built according to this invention, they can be immediately directed to members of the organization that are known to be both responsive to incentives and well-connected within the organization even if these members themselves are not directly familiar with or interested in the content of the entering ideas.

The embodiments of systems and methods of the present invention includes a networked system that provides entrepreneurs, inventors, employees, or other individuals who have ideas or some other creative, intangible work product, the ability to have ideas evaluated, improved, and refined to present the ideas to others for evaluation and potentially development or implementation. This process can be performed in a network, such as a closed private system, such as within a corporation, a closed network with limited external access, in a wide area network open to all, or in a wide area network open to invited individuals. In each case, the network typically has terminals or personal computers for use by users, and some combination of local and wide area networks interconnected by servers.

In one embodiment that relates especially to venture capital or other organizations focused on financing, an entrepreneur can exchange a potential equity interest, which amounts to a stake in the future success in an idea, in return for expert advice provided by system experts. The exchange allows entrepreneurs to trade potential equity as idea shares, which are a form of private currency that can be converted to equity in exchange for the expertise of others, and/or for exchange for other types of professional services provided by third parties, such as accounting, legal, programming, or web design. If the entrepreneur incorporates, for example, the equity can be converted automatically to founder's stock. The exact event that triggers the conversion of the idea shares is not necessarily incorporation but may be, instead, a funding event, or the signing of a record deal. The exchange assists entrepreneurs in developing, improving, and refining ideas, and ultimately in securing financing. It assists financiers by improving on ideas and by allowing the exchange to reveal its opinion of the ideas through a rating developed by a market mechanism before the ideas are presented for financing. The system also provides access to different opportunities for people who are interested in consulting for a start-up or emerging idea but cannot or do not desire the full commitment.

The system thus provides a mechanism that defines property rights over intellectual property, e.g., as entered into a web site, and then standardizes the rights to the intellectual property so that such rights can be traded among individuals, e.g., in an exchange over the web, before the intellectual property has any corporate substance. If that intellectual property turns into a corporation, idea shares provide a share of that corporate equity. The system thus delivers liquidity before funding. For the entrepreneur, the system thus provides a standardized financial/legal instrument, a custodian who keeps a record so that conflicts may be resolved, and independent third parties who render their opinions in a fashion that such third parties commit time (and possibly other resources, such as their reputation, or the ability to commit to other ideas) and have a stake in the outcome. While the idea shares can be ultimately exchanged for actual stock if the entrepreneur incorporates, they can also be exchanged for professional services or other value through the exchange, thus demonstrating the flexible liquidity. Thus in general, the shares represent a means of valuing an idea, with that value determined by interactions between the person who generates the idea and other participants in the system, and potentially from the results or outcome from the idea.

This mechanism of defining property rights allows members of a system built according to the present invention to also communicate negative value both implicitly and explicitly. For example, members of the system can reveal their negative valuation of an idea by refusing to receive idea shares from that idea, preferring instead idea shares from other ideas. The system may also allow members to reveal negative valuation about an idea explicitly through “short selling”, e.g., by allowing members to sell idea shares that they do not own (in the idea they value negatively) on the credit of idea shares that they do own. These members would then realize a gain if the idea shares in the idea they value negatively become worthless

The exchange and method of the present invention include a system whereby a body of experts who are people with some knowledge and/or experience in evaluating the ideas themselves or the business of those ideas is available to interact with the ideas and the entrepreneurs. The experts are preferably restricted to those who are invited by the exchange. The experts are arranged hierarchically into relatively lower level experts and higher level experts along a series of steps. Ideas preferably get presented to the lower level experts and through various mechanisms are filtered as they pass to the highest levels. In exchange for such assistance, idea shares are provided to experts from entrepreneurs, although a pyramidal system is not necessary and an entrepreneur could select from a range of potential expert levels from the start, or higher level experts could seek out opportunities and work directly with an entrepreneur from an early time.

The exchange and method of the present invention preferably also includes a rating system. Ideas can be rated as they move up from experts at one level to another, entrepreneurs and experts can be rated from prior experience, and experts can be rated based on the results from ideas with which they are associated.

Unlike content being rated and correlated by collaborative-filtering systems in which a consumer buys a book or downloads a piece of music without changing the content of the book or music, the nature of the interaction for future users, in the system of the present invention ideas can evolve by the user interactions and derived ratings; for example, the system for rating ideas may be used to prioritize and rank the many possible applications of the idea. Also, evaluators can recommend ideas based on their input to the idea.

This system also preferably includes a flexible system for providing information between experts and entrepreneurs in a public manner or subject to a nondisclosure agreement. The system provides publicly accessible information about an idea, and hidden information that can only be accessed by the expert agreeing to non-disclosure terms. These terms are preferably standardized, and accepted by the expert by clicking onto an acceptance button, at which time the expert gets access to more detailed and non-public information. The entrepreneur and/or the expert can remain anonymous at this stage, yet be credible, because their credentials are verified in advance.

The system and methods of the present invention can be implemented through a broad-based network that connects a multiplicity of processing devices that may not be always connected to each other, such as a company intranet, and preferably through the Internet. As such, the system includes one or more processing devices which act as servers for interacting with the various parties, including experts, entrepreneurs, and other service providers, either for subgroups, such as found in a peer-to-peer network, or for the entire community, such as found in a client-server environment, and preferably implemented as a web server communicating using HTTP. The servers have one or more programmed processors and are coupled to storage that can be resident in the server or remote from the server for holding information including information relating to the various parties that interact with the exchange.

The methods of the embodiments of the present invention can be implemented in software that can be stored on optical or magnetic media, such as a CD-ROM, having a substrate and configured to encode such software to be read and executed by an appropriate reading mechanism.

Other features and advantages will become apparent from the following detailed description, drawings, and claims.

### BRIEF DESCRIPTION OF THE DRAWINGS

FIG. 1 is a block diagram illustrating a system according to an embodiment of the present invention.

FIG. 2 is a diagram that illustrates how ideas may be filtered up through levels of experts.

FIG. 3 is a diagram that illustrates how ideas may be exchanged in a corporate environment.

FIGS. 4 and 5 are exemplary graphs that can be generated according to an embodiment of the present invention.

### DETAILED DESCRIPTION

The system and method according to embodiments of the present invention can be used for evaluating ideas, including other intangible creative efforts, based on the interactions of individuals who evaluate and promote those ideas and the resulting outcomes from the promotion of those ideas. The system can be used in the context of an entrepreneurial startup exchange, an internal corporate idea submission system, a publicly available website, or some other network, for example an internal corporate network with some limited external access to other parties. The system and method of the present invention are first described in an embodiment relating to an entrepreneurial exchange.

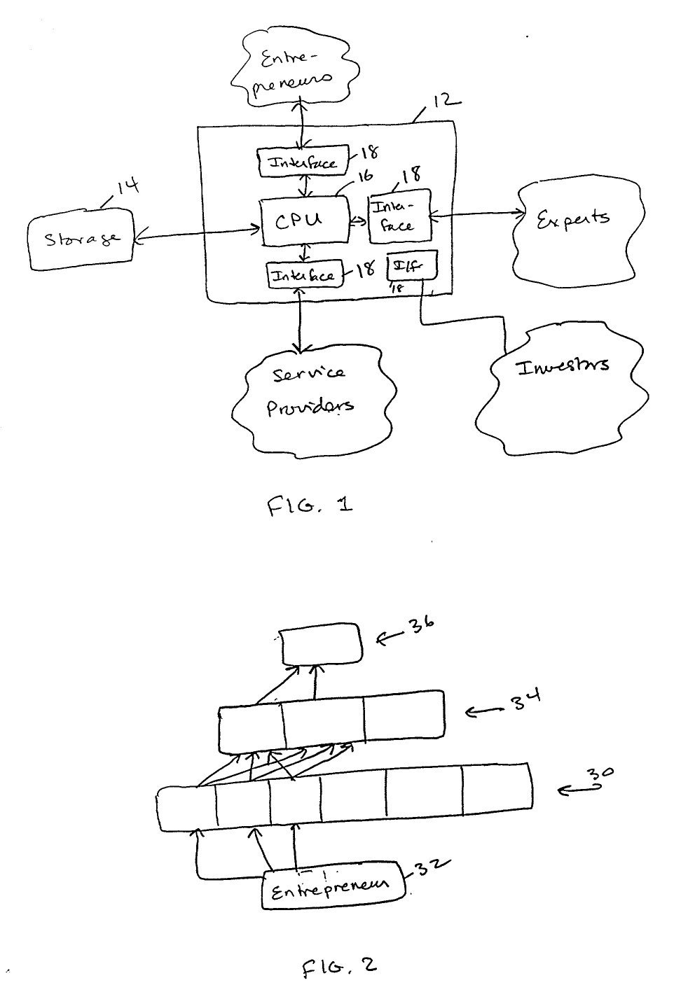

Referring to FIG. 1, the first embodiment of the system and method of the present invention are preferably implemented through a wide area network that is generally accessible to the public, as opposed to a closed and limited access local area network, although a version could be provided in a closed private network, or in a partially closed network with some limited external areas. The wide area network may have access and availability subject to password protection and other security measures.

The preferred network is the Internet, with the system including one or more web server 12 and data storage 14 for storing information. The web server allows interaction among individuals in different groups that interact with the system, and includes one or more processors, represented as CPU 16, and interfaces 18 for interacting with the individuals. The system can be controlled by individuals who operate the exchange, referred to here in this embodiment generally as “system administration,” for monitoring activity and providing access, and performing other administrative and management control functions or the system (this administrator or administrative functionality may also be referred to as the “advocate” as in another embodiment below).

The various users that interact with the system can include at least entrepreneurs and experts, but also service providers, financiers/investors, and others. The entrepreneurs are individuals or groups of individuals who have intangible work product, such as business ideas, that may be at an early stage of development, at the stage of a completed business plan, or anywhere between these stages. The nature of the work product is that it is subject to improvement and/or refinement from people with expertise in evaluating and/or building on that work product.

The experts who participate in such an exchange are preferably invited to join the system as experts and have useful knowledge in the development and/or evaluation of business ideas generally, although the system could be open to classes of individuals without specific and individual invitation. These experts can include people with varying types of experience that relate to new business ideas, such as people with business, technical, legal, and/or management experience. The experts may be all known to each other, may be anonymous to each other but known to the entrepreneur or other idea submitter, or may be anonymous (except possibly for credentials) to all others in the system. The same is true of members of any other group within the system.

The experts are preferably arranged in a hierarchical manner. In one embodiment, at a lower level, the experts may include people with moderate levels of technical or business experience, such as business school students or basic engineers. Top level experts may include highly experienced executives and consultants. An alternative or an additional hierarchy of experts would be slotted in a continuum of experience level and reputation as designated by system administration or through the system's own experience as the system evolves. Alternatively, the experts could have similar accessibility to the entrepreneur from the start, without a pyramidal recommendation, although higher level experts may prefer that ideas be refined and go through initial screening before they commit time to them, as the pyramidal structure allows.

Any individual may be allowed to register online with the system as an entrepreneur, or the system administration may determine that only a group of people, limited by criteria such as background or group affiliation, may be allowed to join as entrepreneurs, in order to keep the quality of submissions high. The system administration will verify the individual's identity before providing full access to system resources, and will put the entrepreneur through an interview process to determine the background of the entrepreneur. In the interview stage, the entrepreneur may be asked to provide some basic information, e.g., at least the industry segment that his or her idea addresses, and as much (or as little) information as he or she wants to disclose beyond that basic information. Once the interview has been completed and the entrepreneur's identity has been confirmed, the entrepreneur is provided electronically with a number of idea shares that are maintained in storage in the system. Through agreement between the exchange and the entrepreneur, these idea shares correlate with some amount of founder's stock or other equity in any resulting incorporated business.

With this embodiment of the system of the present invention, an entrepreneur may submit an idea or business plan or other information through a server to a lower tier of experts. The experts can specifically be selected by system administration based on the nature of the proposed idea and/or the revolving use of these experts. Alternatively, the entrepreneur can broadcast general features or characteristics of an idea and elicit one or more of the lower level experts to consult either by broadcasting to a whole group or by requesting assistance from those with specific experience.

The experts may be required to submit resumes including information about themselves and their experience, and including name and current position; alternatively, the identity of the experts can be kept hidden for some period of time from the entrepreneur except for a description of the person's qualifications in general terms. In addition, over time, even if the expert's identity is kept hidden for some period, that expert's record with other ventures may be provided, such as, for example, an indication that the expert had previously consulted on two funded ventures, one non-funded venture, and two pending ventures. The nondisclosure agreement (the “NDA”) can be created such that both parties will be bound, even if they do not know the identity of the other party.

The owner of the idea may provide one or more “teaser” sections whose content is meant to clarify the idea in broad strokes and entice a reader to sign a nondisclosure agreement (NDA) and read the proprietary aspects of the idea if a common interest exists. If the expert is still interested in the idea of the entrepreneur, the expert and the entrepreneur can make an agreement whereby a number of the idea shares allocated to the entrepreneur are provided to the expert in return for that expert's services. The services can be, for example, hourly assistance on a weekly or monthly basis, e.g., 5 hours per month or two hours per week. The agreements between the experts and the entrepreneurs can be individualized between them as parties, or a series of form agreements can be generated by the system for different types of assistance and arrangements. The number of idea shares can be negotiated, and thus the person possessing the idea shares has the ability to allocate among individuals and for different ideas. The expert thus receives potential equity in return for his or her expertise, and the entrepreneur obtains expertise without cash outlay. These idea shares are thus distinct from cash and serve as a new form of equity, which may be binding financial interests or a social reward system without a distinct monetary value.

Because the experts may have experience and contacts, they can further assist by identifying potential key employees that would serve as a good match for the entrepreneur's company. Experts may still be anonymous to the entrepreneur, but can arrange introductions to such specific, pre-identified parties that otherwise might not interact with the entrepreneur directly. These experts providing the interactions may get rewarded for each introduction by the entrepreneur even though the experts may choose to remain anonymous.

The idea shares that are exchanged are preferably convertible into founder's equity (or royalties or some other stake after the idea is more formally pursued) if the entrepreneur incorporates with the idea (or if another, pre-agreed trigger requirement is met, such as a funding event), at an exchange rate previously agreed to. For example, the entrepreneur can receive some number of idea shares, such as 1,000, and arrange a rate at which they're convertible into founder's equity in a resulting corporation. For example, assuming that the idea shares constitute 50% of the founder's equity, if the total number of idea shares is 1000 and if 600 (or 60%) of the idea shares are provided to experts, the experts collectively will receive 30% (i.e., 50% of 60%) of the founder's equity.

The idea shares can also be exchanged with service providers, such as accountants, lawyers, web designers, or landlords. External system administration, like other service providers, can also be compensated with idea shares for establishing and/or operating such a system. The idea shares can also potentially be exchanged in the same manner, i.e., some number in exchange for an amount of services or a set project.

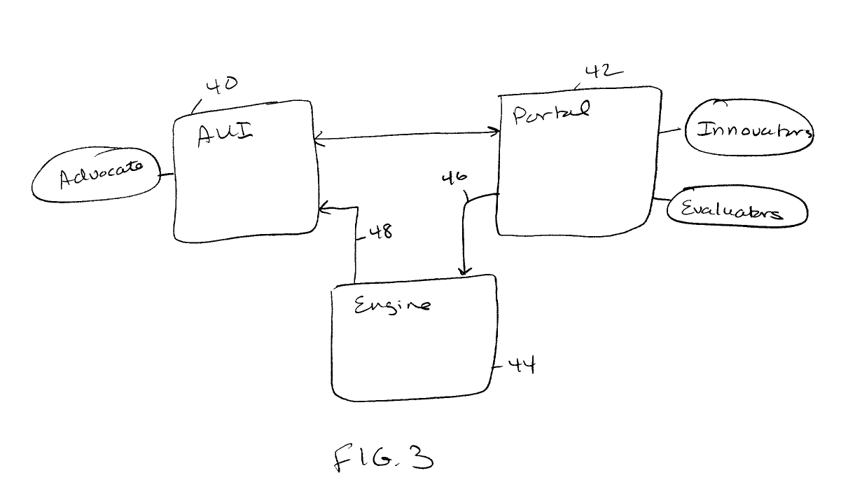

FIG. 2 illustrates an example of a hierarchy of experts. A lower level 30 of experts can work with entrepreneur 32 to develop and refine the idea. The experts in lower level 30 can then submit that idea to a lesser number of experts at a higher level 34. These higher level experts will have more experience or more significant and relevant talents. As shown in FIG. 2, the entrepreneur has an agreement and provides information to three experts at lowest level 30. These experts, after working with the entrepreneur provide the idea as refined with their input to two experts in level 34 with more experience. The two experts at level 34 then can provide consulting services on the idea in order to refine and potentially improve the idea. After providing their expertise, the experts in level 34 can provide the idea (as received or as refined) up to a further expert at highest level 36.

At the stage of the highest expert, the idea will have been reviewed by one or more highly qualified experts who can bring credibility to financiers, in addition to having been reviewed by other lower level experts as well. At each stage, the experts are expected to independently evaluate the idea and perform their consulting work on it. For the benefit of their own credibility, the experts should be careful not to recommend to a higher level ideas that are not worthy or ready to be passed up. Furthermore, promoting an idea that is not promising causes the expert to provide his or her energy or time and possibly other resources. In addition, other limits can be imposed to enhance selectivity, such as how many ideas one expert can evaluate over a given time frame, e.g., one every three months.

The experts are preferably independent of each other, and each has an agreement as an arm's length transaction with the entrepreneur. This system is thus different, for example, from a venture capital firm where people may have different levels of experience and report up a chain of command but are in a common organization. Even within a venture capital firm, a deployment of this system would be different from the current way it operates as is described in the embodiment that follows relating to internal company operations.

The hierarchy shown in the embodiment of FIG. 2 is simplistic, but such a hierarchy could use a wide variety of number of layers and number of people at difference layers. The number of ideas that lower level experts submit to next levels may be limited by rules of the system, or, after a period of experience has evolved in which experts become rated based on the value of ideas that they present, the system can be effectively self enforcing, e.g. by changing the level of an expert from their starting level based on their performance to date. As a result, the system could rearrange experts over time, with the original hierarchy being used as a starting point to jumpstart the system. For each group of experts that provides assistance, idea shares are transferred from the entrepreneur to the expert using a similar mechanism as described above, namely, arms-length transactions between the entrepreneur and the expert. Alternatively, the lower level experts could be allocated idea shares and be required to bargain with the higher level experts, thus allocating among the experts the idea shares initially granted.

At some point, when the idea has been presented to a sufficiently high level, the idea may be suitable for presentation to financiers, at which time the idea will have a rating based on the identity and skill of the experts who have agreed to participate in supporting, and thus effectively sponsor, the idea. The rating can also take into consideration the number of shares that are transmitted, with a lower number of shares being favorable, as such lower number would indicate that people are willing to serve as experts for a lesser amount of idea shares in return, thereby suggesting that experts are relatively eager to participate.

Based on experience, ratings can also be established for experts and entrepreneurs. Ratings can be established for entrepreneurs based on the previous experience of the ideas they have offered, and based on whether their ideas are ultimately financed and incorporated. Experts can also be rated based on a record of whether ideas that they have promoted to higher tiers of experts are ultimately financed and incorporated and also on whether their recommendations to higher layers are indeed accepted by those in the higher layers, and eventually, whether they are successful. This embodiment of the system thus provides objective measures for rating ideas, experts, and entrepreneurs based on interactions and outcomes, and is not dependent on a subjective review by system administration or any external content-based review.

What is thus provided is a system and method for evaluating and rating a party's interactions, using the outcome and the party's interactions as a basis for value. A party actively involved in a matter with a good outcome will thus score well, while a party actively involved in a bad outcome or minimally involved in a good outcome will not score well.

This rating system for ideas judges the rated venture based on the credentials of the parties to a market transaction and the price achieved. The credentials of the parties are objectively measured and verified, e.g., academic achievement. Thus, the rating does not represent an opinion formed by the system but is an objective market measure. It also differs from other objective ranking systems (e.g., systems that rank web-sites based on site traffic), because it incorporates the credentials of the counter-party and also the price achieved in the transaction. For example, the system could be set up with double-blind encryption so that system administration has no way to access the content represented by the idea shares and yet can deliver an objective rating based on the interactions of the system's members. The system thus is content neutral with outcome information and interaction information determining the value.

The experts are thus paid to perform a service that costs them their time and reputation within the system. The rating is a market-based rating and not based on third party subjective opinion. Rather, the rating objectively provides reported results of interactions that are costly to both sides. The system thus reports the rating and serves as the custodian of ratings. The system may be called upon to independently verify facts, such as that a particular expert has entered into a transaction with a particular entrepreneur, that the expert is really an expert in the field, and that it is costly to the expert.

Idea shares may be traded after incorporation. At that point, the idea shares have become equity and the system is providing the electronic network over which corporations may trade equity for services in a standardized fashion.

An expert that identifies an entrepreneur can introduce that entrepreneur to the system, possibly for an additional referral fee. That entrepreneur has an incentive additional to the other benefits in that there will be an initial rating that will separate that entrepreneur from the others. Investors may also refer entrepreneurs with the assurance that, if the idea satisfies a minimum requirement (e.g., a minimum rating), the entrepreneur is charged fewer idea shares to use the system provided that the entrepreneur secures funding from the referring investor.

Idea shares also allow for development of more members (e.g., experts or entrepreneurs) through commissions. For every expert recommended to the system the idea shares can be used as a referral.

Another way that the liquidity can be used is that experts can trade idea shares with others in a pool of idea-shareholders for diversification purposes, effectively creating a pre-venture portfolio.

The entrepreneurs can each have access to the publicly available aspects of ideas from other entrepreneurs. If the ideas could be combined or work together, or if the parties could be in a mutually beneficial relationship (e.g., supplier and manufacturer), the system can arrange introductions at the request of one and approval by the other.

As these examples indicate, there are a number of ways to liquidate a party's interactions and involvement.

At the disclosure stages, the flexible online NDA system is provided to allow entrepreneurs to protect specific parts of their ideas while revealing enough to entice the reader to sign them electronically and while binding the reader to as narrowly defined a concept as possible, thus making the reader more likely to sign the NDA electronically. With these electronic NDAs, the agreement between the parties is achieved online although the parties may not know the identity of each other beyond the credentials verified by an independent third party, such as the maintainer of the system. The NDA covers only specific, pre-described content, such as the answer to a specific question, or a brief summary of the idea. In the case of a system deployed within a company, where all intellectual property belongs to the company, the NDA may be more a statement and agreement of the origination of the idea with one of the parties, instead of a nondisclosure agreement in the strict sense of the word.

The online NDA preferably includes an authentication mechanism that ensures that only parties whose credentials satisfy the requirements specified by the owner of the information may sign the NDA and view anonymously the protected content, possibly without interaction with the owner of the protected content.

The owners of the idea from a venture can then provide the venture with equity-based incentives for extending its business relationship within a loyalty program. For example, a service provider that has been paid by a venture in equity can allow the venture to earn back its equity from the service provider if it engages in business transactions with third parties of the loyalty program (or even the original service provider). These third parties may then compensate the original service provider for providing such an incentive to the venture.

Referring again to FIG. 1, the storage can be used to maintain, for each entrepreneur, business plans and other information about the company to be shared with the experts, numbers of ideas shares, the relationship of which experts are associated with which entrepreneurs and which are not, ratings, and other useful and accessible information about the entrepreneur. With respect to the expert, similarly, the system may maintain information about how many idea shares that expert has and other biographical information, historic information with the system, and various other useful information about that expert. By providing extensive storage and encouraging the parties to communicate as much as possible electronically through the system, the storage can record the date, time, and substance of the communications. This is useful for monitoring quality, resolving disputes, and maintaining a useful record of the transactions.

The network technology necessary to implement the system and methods of the present invention are generally known, including providing limited access to certain information, recording communications between parties, providing online agreements and click-boxes for accepting those agreements, and various other processing and storage functions.

In addition to the electronic and virtual exchange contemplated herein, bricks and mortar regional venture centers could be established to provide information and meeting spaces for experts and entrepreneurs, and eventually financiers.

As mentioned above, the system of the present invention can be used on a private LAN or on an intranet for internal corporate purposes, or with limited external access.

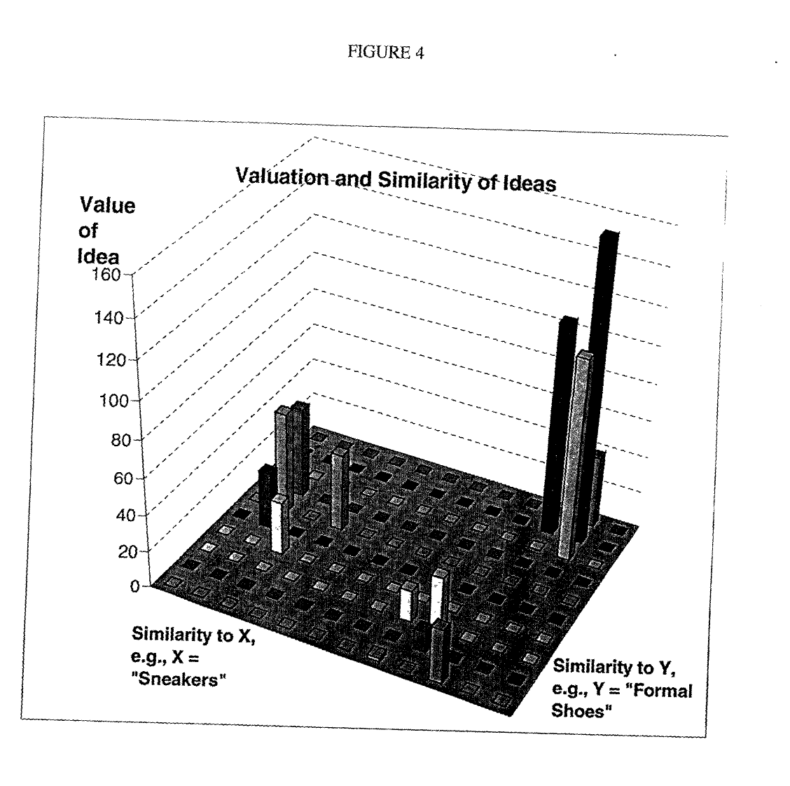

Referring to FIG. 3, in an embodiment for an internal corporate network (which may have some third party access, such as consultants, customers or advisors), an internal innovation advocate is comparable to an administrator, while the entrepreneurs and experts described above are comparable to various levels of employees and consultants with different levels of technical and managerial skill within the enterprise. These parties may still be considered “entrepreneurs” and “experts” respectively within the organization, and referred to as such herein.

A customizable and intuitive advocate user interface (AUI) 40 presents the advocate with real-time analysis of the corporate innovation effort. The AUI can help the advocate refine the innovation strategy and can also offer optimized action items for aligning the innovation effort with the overall strategic plan. The advocate's decisions are implemented over a portal 42, which is an internal peer network where innovators and internal experts are provided with guidelines, incentives and collaborative tools for executing the innovation plan. Data 46 from the portal, which are indicative of interactions among innovators and management, are submitted to an engine 44 that uses statistical methods to derive an analysis of the interactions. This analysis 48 is presented to the advocate at the AUI and to network participants in the portal.

The analytical framework for advising the advocate is essentially an asset-based approach to innovation. This framework focuses on measuring and analyzing the performance of the assets in the innovation portfolio, i.e., the ideas and the people involved.

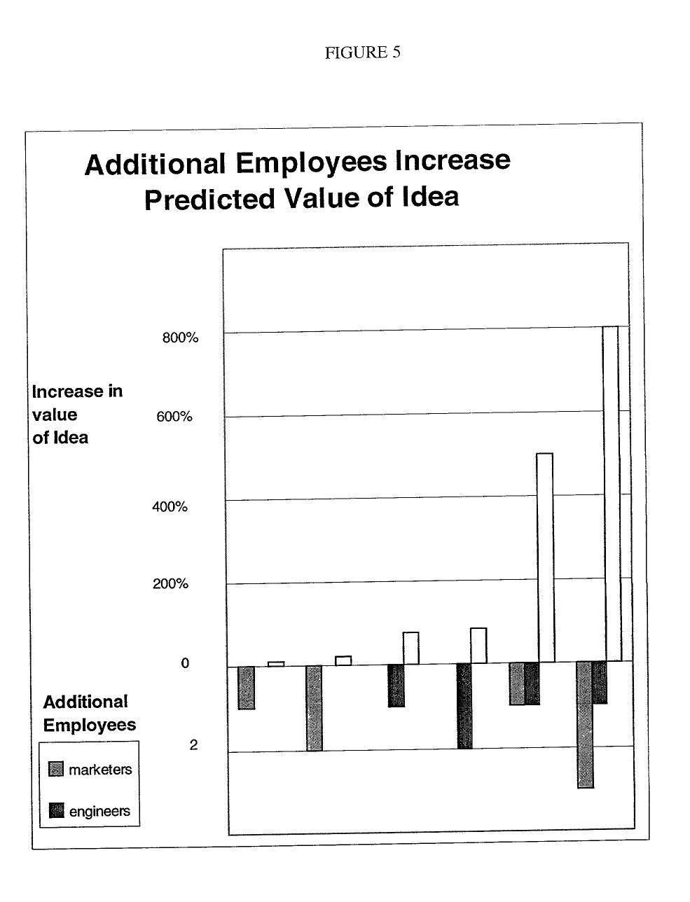

The analysis from the engine is presented via a real-time, enterprise-wide innovation map of the value in the innovation pipeline. Referring to FIG. 4 as an example, a map can help to discover complementary projects across business units and to identify promising innovative activity before the developing ideas have an empirical track record.

Based on the analysis from the engine, the advocate user interface can also suggest ways for increasing the value of the innovation pipeline. As shown in the example of FIG. 5, the system may suggest that a certain group of employees is underrepresented relative to their value-add; or that innovation in a crucial area is lagging relative to its strategic importance. The advocate can then implement any desired changes through control of the innovation portal.

The portal establishes a private and secure innovation network for participants to post and track ideas, manage the privacy and confidentiality of their submissions, and communicate and collaborate with others using an innovator-friendly interface. The portal also offers an embedded incentive-management system where participants may trade idea shares with each other, or may receive idea shares from the system in exchange for performing due diligence on ideas promoted by the system. For each idea in the portal, idea shares represent an incentive bonus that the corporation is willing to pay to the team of employees that successfully executes that particular idea.

An advocate can implement an innovation plan over the portal by controlling the submission process; by setting the milestones for idea advancement within and beyond the portal; and by aligning the incentive mechanism with the advocate's strategic vision. For example, the advocate may offer rewards to individuals or groups with desirable characteristics or allocate due diligence resources to certain areas.

The engine produces an analysis with dynamic statistical model of

(a) the value of each participant based on past history and each idea based on outcomes;

(b) the relevance of each participant and each idea; and

(c) the rate of the diffusion of innovative ideas across different groups within the company, i.e., the interactions.

The model is dynamic, continuously processing raw data from all the portal interactions, including the idea shares transactions if applicable or the promotion by individuals. The engine optimizer then searches for ways to improve the allocation of resources and presents the advocate with the results.

The approach is thus based on actual interaction data, leveraging the collected operational wisdom of the network of in-house experts that interact with the portal. It is desirable to use interaction data because early-stage innovative ideas do not yet possess empirical metrics such as revenues or failure rates, rendering typical consulting approaches less useful. Similarly, early-stage innovation evolves too rapidly for content-based approaches alone, although it may be desirable to implement content-based approaches on the strength of the analysis resulting from our interaction-based approach. To separately identify the effect of each party in the data points from interactions, simultaneous equation estimators from econometrics and finance are employed, as well as other statistical, pattern-recognition, and incentive-management approaches.

There are many ways in which the system and method of the present invention can be utilized. For example, in a company that generates many new products, engineers or employees can submit those products for evaluation. It will be in the interest of those submitting the idea to refine that idea as far as possible to attract interest from others within the corporation. Others within the corporation, such as those with expertise in marketing, sales, manufacturing, and engineering can evaluate the different ideas that are submitted and serve as a filter for the more promising ideas. In addition, there can be interactions across different groups to determine feasibility, such as whether the marketing should be done at a particular time and how long it would take to engineer and manufacture products.

Idea shares in some form may be used as a currency so that those who submit ideas or evaluate ideas are essentially required to allocate among the various ideas that are submitted or allocated. In other cases, the outcome alone can be used and thus encourage individuals to promote only the best ideas. Furthermore, if an individual needs to commit resources of time and effort, that may be the measure of the submitter's or expert's commitment and avoid the need for exchange of shares as a reward or allocation means.

Variable numbers of idea shares can be traded, thus reflecting a person's belief in the strength of the idea; thus an individual may promote multiple ideas, but can effectively weight his or her assessment by how many idea-shares are traded in a transaction. For a high potential idea, a submitter may not have to give up as many idea shares, and an evaluator may take fewer shares.

In an alternative arrangement in which idea-shares represent points that indicate belief in an idea, a submitter may allocate idea shares among multiple ideas, with some getting more idea shares. In that case, evaluators may also add on their shares as well, so that when ideas get to top management, they have a value representing the value put on the idea as it passes among evaluators.

In other embodiments, users may receive directly from the system offers of idea shares in individual ideas or of baskets of idea shares from many ideas, i.e., the system may push idea shares to users. For example, entrepreneurs may allow a certain percentage of their idea shares to be offered by the system to well-regarded experts strictly for their opinion. In that case, the system may ask an expert to review three pre-selected ideas on the system. To reward the expert for reviewing these three ideas and to ensure that the expert will indeed review all three of the ideas, the expert is allowed to choose between receiving either a greater amount of idea shares in one idea of his choice, or basket made up of a smaller amount of idea-shares in any two ideas of his choice.

In short, idea-shares are a flexible currency instrument that can be used in one of many ways to allow individuals within an organization to place a value on ideas as the ideas are being evaluated.

If a product is ultimately developed and sold, the resulting profit and loss can be used to assess the outcome from that idea and the interactions can be used to score individuals involved in the process. With idea shares, a party that had many idea shares, in a system constructed so that a party seeks to hold such shares to represent his or her belief in the idea, would benefit greatly if the outcome of the idea is significantly good.

The system can determine whether an individual submits a small number of ideas with a high probability of success versus many ideas, few of which are successful. For the levels of individuals who evaluate the ideas, a score can be provided based on the extent to which the individuals promote successful ideas within the organization. While profit and loss is one logical mechanism for measuring success, other measurements could be used such as units sold or profit margin, and the organization could try to determine to the extent that the success of one product assists in the success of others. Some credit can be given for an idea being advanced by others, even if not ultimately developed, and in some cases, the adoption of an idea might itself be the outcome.

When an individual submits an idea, the group that sees the idea for evaluation may be a large and fixed group, or can be determined by the administrator by selecting individuals. Alternatively, the system can use an optimizing function to look at different individuals to see how they score, and to try to balance the scores of individuals in all areas being evaluated. If individuals submitting ideas are allowed to weight those ideas, an idea that comes with a high rating could be provided to a team of individuals who have a generally high score in promoting successful ideas because in that case the submitter has indicated that he or she believes it is a promising idea. Individuals who have high scores and a proven record of good evaluation of ideas could intentionally be provided at a lower level to filter out ideas, or alternatively, the system may be designed so that such a person only evaluates the ideas after they have been filtered through others. The ideas that are thus provided to a high scoring evaluator will have their own score based on the scores of the person submitting the idea and based on the person who submitted the idea and based on the people who have previously evaluated the idea. Consequently, high scoring submitters with high scoring evaluators who promote the idea will move to other higher evaluators with a very high score with lesser scorers and lesser interest producing a lower score for the idea. The system thus can measure individual performance as it measures the performance of the corresponding idea.

The ideas can take the form of new product ideas, but could also be technical improvement, marketing channels, sales leads, territories, different ways to bundle or package products, manufacturing efficiencies, or any other potentially useful business ideas.

As indicated previously, the scoring is preferably done in a content neutral manner such that the system need not know exactly what the idea is or any details about that idea except to know that it had a certain level of interaction and a certain outcome. Content evaluation could be added, although this would add a level of subjectivity to an otherwise objective system.

The system and method according to this embodiment of the present invention would be implemented through a network with an engine that includes processing and storage capabilities. The processing can be performed by one or more computers, and the storage would typically be a database or some other system with the ability to store the needed information. The programs by which the operations of the engine are executed can be stored in a medium, such as an optical disk, for use in other machines. The programs can be written in any of numerous ways to address particular problems and particular concerns associated with the institution.

Factors that would be considered and could be written into programs for evaluation by the engine include some measure of an outcome of an idea, and some measure of various interactions that take place in the development of the idea, such that even if the idea is not ultimately adopted, a form of “credit” could still be provided to the person who submits the idea. For example, an idea submitter might get a certain number of “points” or other credits for the fact that three out of four people reviewing the idea thought it worthy of submission to the next level of management. The calculations are dynamic in that actions by individuals during evaluation of one idea can affect that individual's scoring for purposes of other ideas.

The following is an outline of an exemplary process for calculations:

1. A number of ideas, for example 100, submitted by entrepreneurs of the community.

2. Each idea gets pushed to 5 “experts” who are selected based on the stage of development of the idea, and whose diversity for a given idea is guaranteed by their having been profiled on past transactions and interactions, to gauge their interests and optionally incite them to perform services for the entrepreneur in exchange for idea shares.

3. Based on the interactions and potentially idea shares transactions of the 5 users, and on their prior interaction histories, the idea is initially valued.

a. For each idea shares transaction, an implied idea valuation is constructed by the system based on that transaction and all prior idea shares transactions for that idea. For example, an idea may be valued as the sum of the equity fraction transacted multiplied by the estimated hourly wages of the “expert” member being employed, divided by the total equity fraction transacted over all transactions.

b. Based on the categories of supporters that each idea gathers, its valuation is determined. For example, an estimate of value is the weighted average of the implied valuation of each idea shares transaction. The weights would be constructed in a way to penalize an idea for having all supporters being from the same group of members, and to reward an idea for having a diverse mix of members from all expert groups.

c. In addition to the value, an index of the risk of the idea is determined based on how dispersed the implied valuations from each transaction are. The index of dispersion may be further adjusted to reflect greater risk if the qualifications of the supporting members are closely correlated.

4. Based on step 3, it is determined whether the idea should be sent to any other users for evaluation, and, if so, which users. On average, each idea gets presented to 5 more users, although some ideas may not be presented to more users at all. In parallel, it may be possible that the users in step 2 will send the idea by themselves to other, more experienced users.

a. Following each interaction and transaction of the ideas that are still active the valuation and risk metrics of each idea are re-evaluated.

5. The administrator of the system determines whether to pick the top ideas, or whether to pass the top ideas back through the system to cull out more ideas. For example, the top 10 ideas to get this far may be passed back to step 2, this time being presented to more expert members of higher qualifications.

6. Every user is profiled based on how the user interacted with each idea so that similar users can be identified. Furthermore, each user is also profiled based on the ability of the user to successfully identify the ideas that get promoted to the next level of experts.

7. When new ideas get submitted, proceed to step 1, with the profiles gathered about the users being used to ensure that ideas are viewed by a diverse group of initial experts in step 2, and by a relevant group of experts in step 4.

The system and method of the present invention thus allow a measure of interactions among many individuals. Each interaction, by itself, may reveal little or no information about the relative contribution of each party. The interaction indicates that each party thought it was worthwhile to contribute to that interaction the time, or idea shares, or expertise that are observed. The system and method back out each party's opinion about the other party, the relative contribution of each party, and everyone else's opinion about each party by looking simultaneously across all the interactions that are observed. Relative to a party A, the system learns about party B by looking at every interaction that included B but not A. This can be repeated for every pair-wise combination and the information used from every pair-wise analysis to learn about every party.

In another example of an embodiment of a system and method for evaluating ideas and interactions, an online system for creating petitions and feedback campaigns can utilize a publicly accessible internet site that tries to encourage petitions and actions among the public. In this case, individuals who submit ideas or who email these ideas to others and thus encourage additional support for such ideas will obtain a high score for that person's level of interaction. The system can be done in a private manner such that individuals can be known only by number, and the system can also be made to be content neutral, so that the content of the petition is irrelevant to evaluating the extent to which an individual is able to create support for his or her ideas.

In the case where the outcome may be petition signatures and supporters, the number of people that sign a petition initiated by an individual is the outcome and scoring can be provided for the person who initiates as well as for others who are involved with promoting the petition.

From this information, the system can be used to determine the individuals who are more likely to promote successful petitions and who have the ability to convince others to assist. With this information, the users who are most accomplished at this can be used in an analysis role.

Even though the submitted ideas are petitions, the system can operate in a content neutral manner in that it does not matter what the content actually is for the system to measure the interactions. The system could be used to establish broad categories of petitions such as environmental, educational, or issues local to a particular area. In that case, the system could still associate petitions with each other again without necessarily revealing the nature of the individual's interest, but only his or her ability to promote petitions in this area.

Having described preferred embodiments for the present invention, it should be apparent that modifications can be made without departing from the scope of the invention as defined by the appended claims. For example, the system can be used beyond its currently described application of rating business ideas into other broader types of ideas, such as music. In this case the owner of the music (the band) can offer “music shares” (i.e., rights to songs) to music experts in order to attract one of a limited number of potential endorsements.

What is claimed is:

1. An idea presentation and evaluation system that allows evaluators to evaluate ideas from idea submitters, the method implemented in a network and comprising:
the network receiving an idea and presenting it to a first group of evaluators, the network allowing any of the first group of evaluators to refer the idea to a second group of evaluators;
the network including a processor for monitoring interactions between the first group of evaluators and the second group of evaluators including referrals;
the system maintaining and storing data relating to the interactions and assessing a value to each of the first group of evaluators based on the interactions.

2. The method of claim 1, wherein the system also assesses a value to a party presenting the idea based on the interactions.

3. The method of claim 1, wherein each of the second group of evaluators can refer the idea to a third group of evaluators.

4. The method of claim 4, wherein the system also assesses a value to a party presenting the idea based at least in part on the interactions between the first and second group of evaluators and at least in part on the second and third group of evaluators.

5. The method of claim 4, wherein the value associated with the each of the first group of evaluators is based in part on interactions between the second and third group of evaluators.

6. The method of claim 2, wherein the system assesses a value based in part on an outcome of the idea.

7. The method of claim 6, wherein the outcome includes one of whether the idea is developed, whether a resulting product is profitable, or whether a further action occurs with respect to the idea.

8. The method of claim 4, wherein the system assesses a value based in part on an outcome of the idea.

9. The method of claim 8, wherein the outcome includes one of whether the idea is developed, whether a resulting product is profitable, or whether a further action occurs with respect to the idea.

10. The method of claim 1, wherein the submitter is provided with shares to allow the submitter to allocate a value to a submitted idea.

11. The method of claim 10, wherein the evaluators are also provided with shares to allow the evaluator to provide such shares to submitters and/or to other groups of evaluators to allocate a value to the idea being evaluated.

12. The method of claim 10, wherein evaluators are allowed to borrow shares against an idea for repurchase later, thereby short selling the shares.

13. The method of claim 1, wherein the evaluators are provided with shares to allow the evaluator to provide such shares to submitters and/or to other groups of evaluators to allocate a value to the idea being evaluated.

14. The method of claim 1, wherein ideas are transmitted among evaluators in response to rules that specify one or more of what groups need to consider an idea first, what internal ratings must be generated for an idea to “proceed” to another group of evaluators, and what evaluators are allowed to be in what groups of evaluators.

15. The method of claim 1, wherein the evaluators are arranged in a hierarchy based on corporate hierarchy, education, and work experience.

16. The method of claim 1, wherein the evaluators are arranged in a hierarchy based on values assigned to evaluators based on prior evaluations of ideas and outcomes of ideas.

17. The method of claim 1, wherein the network can route contracts between evaluators and/or between evaluators and submitters.

18. The method of claim 16, wherein the contracts can be routed and executed with the parties being anonymous with respect to each other.

19. A method comprising:
maintaining information about idea submitters and evaluators who evaluate submitted ideas;
assigning values to the idea submitter and the evaluators based on ideas submitted and evaluated, allocations of value being assigned to ideas and interactions between submitters and evaluators; and
causing changes in the values based on an outcome of the idea and further interactions between submitters and evaluators.

20. The method of claim 19, wherein the values are convertible into equity and/or cash.

21. The method of claim 19, wherein the values are convertible into one or more of vacation, time off, an award, publication of achievement, and public acknowledgment.

22. An idea management system that receives ideas from submitters, controls the routing of those ideas between different groups of evaluators of ideas, maintains records of who receives and evaluates ideas, and assigns values to the submitters of ideas, the evaluators of ideas and the ideas themselves based on their interactions between each other and the outcome of the idea.

23. The system of claim 22, wherein the system includes shares that allow submitters to assign a value to when the idea is submitted.

24. The system of claim 22, wherein the system includes shares that allow evaluators to assign a value when the evaluator refers to idea to other evaluators and/or to provide shares to submitters.

25. The system of claim 22, wherein the evaluators can modify the ideas before referring the modified ideas to other evaluators.

26. The system of claim 22, wherein the evaluators are arranged in a hierarchy based on corporate hierarchy, education, and work experience.

27. The system of claim 22, wherein the system includes the ability to route contracts between the parties.

28. The system of claim 27, therein the contracts are routed such that each party does not necessarily know the identity of the other party with which it is contracting.

29. The system of claim 22, wherein at least some of the submitters and evaluators are kept anonymous from each other.

30. The system of claim 22, wherein the outcome of idea includes whether it is adopted and any resulting monetary value from the adoption.

31. The system of claim 24, wherein the system allows wherein evaluators to borrow shares against an idea for repurchase later, thereby short selling the shares.

32. The method of claim 11, wherein a custodian maintains a third-party, independent record of the shares transacted.

33. The method of claim 17, wherein the contracts are made available to individual submitters and evaluators based on the contract parties' group membership or on the contract parties' position in a hierarchy based on one of corporate hierarchy, education, and work experience and prior evaluations of ideas and outcomes of ideas.

34. The system of claim 24, wherein a custodian maintains a third-party, independent record of the shares transacted.

35. The system of claim 22, wherein the evaluators are arranged in a hierarchy based on values assigned to evaluators based on prior evaluations of ideas and outcomes of ideas

36. The method of claim 27, wherein the contracts are made available to individual submitters and evaluators based on the contract parties' group membership or on the contract parties' position in a hierarchy based on one of corporate hierarchy, education, and work experience and prior evaluations of ideas and outcomes of ideas.
